(19) United States
(12) Patent Application Publication
(10) Pub. No.: US 2026/0310857 A1
(43) Pub. Date: Oct. 8, 2026

(54) RAPID ONLINE EVALUATION METHOD FOR CREDIBILITY OF EQUIPMENT DIGITAL TWIN INTEGRATED EVOLUTION MODEL

(71) Applicants: Hangzhou International Innovation Institute of Beihang University, Hangzhou (CN); Beihang University, Beijing (CN)

(72) Inventors: Lin Zhang, Hangzhou (CN); Han Lu, Hangzhou (CN); Kunyu Wang, Hangzhou (CN); Hongbo Cheng, Hangzhou (CN); Lei Ren, Beijing (CN)

(21) Appl. No.: 19/443,394

(22) Filed: Jan. 8, 2026

(30) Foreign Application Priority Data
Apr. 7, 2025 (CN) 2025104260063

(51) Int. Cl. G06F 30/27; G06F 119/02

(52) U.S. Cl. CPC G06F 30/27; G06F 2119/02

(57) ABSTRACT

A rapid online evaluation method for credibility of an equipment digital twin integrated evolution model is provided, which relates to the field of digital twin models. The method includes: S1, performing a rapid online aggregation on unit model error distributions, including: S1.1, dynamically triggering the error aggregation operation; S1.2, simplifying an aggregation computation tree of the equipment digital twin integrated evolution model according to real-time evolution conditions; and S1.3, performing a rapid sampling aggregation on the error distributions according to model mechanisms; performing a rapid posterior correction on the error aggregation result; and performing online scoring on the corrected error distributions of the equipment digital twin integrated evolution model according to user requirements, including: converting the user requirements into an error scoring mechanism, and calculating a credibility value of the equipment digital twin integrated evolution model according to the corrected error distributions of the equipment digital twin integrated evolution model.

### TECHNICAL FIELD

The disclosure relates to the technical field of digital twin models, and more particularly to a rapid online evaluation method for credibility of an equipment digital twin integrated evolution model.

### BACKGROUND

An equipment digital twin refers to a digital twin model constructed for a physical equipment entity. A core characteristic of the equipment digital twin is online self-evolution, meaning that model parameters, structures, or mechanisms are corrected online based on real-time collected equipment data, thereby enabling the model to maintain high real-time consistency with the physical object. However, in practice, it is difficult to deploy equipment digital twins on a large scale and make them truly effective. One of the bottleneck issues is credibility of the equipment digital twin. Only a credible digital twin can accurately and timely reflect the characteristics and state of the equipment, thereby assisting people in making correct decisions. Employing an unreliable digital twin may fail to accomplish predetermined tasks and could even lead to catastrophic consequences. Credibility evaluation is an essential means to ensure the credibility of the equipment digital twin. Due to dynamic evolution and strong uncertainty characteristics of digital twins, traditional model evaluation methods cannot meet the credibility evaluation requirements for the equipment digital twins. An overall equipment digital twin model can be viewed as a multi-level integration of multi-disciplinary and multi-granularity unit models. While there are many evaluation methods for unit twin models in various disciplines and at different granularities, there is currently no suitable method for integrated twin models.

Existing evaluation methods for integrated twin models mainly fall into two categories. (1) Simulation data of a system-level integrated evolution model is compared with measured data, and is quantified into a similarity value, which is treated as a credibility value of the integrated evolution model. (2) The credibility value of each unit model is determined through extensive experiments and analysis, and then credibility aggregation is performed on these values by using methods such as an analytic hierarchy process (AHP), and these values are used as the credibility value of the integrated evolution model. However, both methods fail to meet the credibility evaluation requirements of the integrated twin models, primarily since the twin model continuously evolves online based on real-time data, which leads to constant and unpredictable changes in the model.

For the first category of methods, the integrated twin model involves various unit models, thus possessing significant uncertainty. Furthermore, obtaining system-level measured data for the integrated evolution model is much more difficult than for unit models. This forces such methods to rely on limited, scarce real data to evaluate an integrated evolution model with considerable uncertainty. Clearly, the results obtained can hardly reflect the true credibility of the integrated evolution model.

For the second category of methods, when the unit models are basic models, that is, models that do not evolve with real-time data, their credibility values can be confirmed offline. However, when the unit models are also evolution models, their credibility changes with the uncertainty of the demand scenario and can only be evaluated online. In this case, the integrated evolution model itself is also being applied online, and its real-time credibility directly affects application outcomes, potentially even causing major fault losses. Therefore, it is not feasible to wait for the credibility results of the unit evolution models before integration, the evaluation must be performed online and in an integrated manner.

Consequently, for an equipment digital twin integrated evolution model that contains unit evolution models, its credibility evaluation can only be performed online. This leads to two unresolved problems as follows. (1) At each moment, the integrated evolution model may be involved in applications, its real-time credibility value needs to be updated quickly online to detect newly arising unreliable situations as early as possible, thereby enabling timely response and handling to avoid significant losses. (2) Due to errors between known mechanisms, relationships and reality, integrating credibility through the interrelationships among unit models can cause the resulting credibility value to deviate from the true value. Therefore, it is necessary to rapidly correct the integrated credibility value by using the limited but accumulating real observation data.

### SUMMARY

A purpose of the disclosure is to provide a rapid online evaluation method for credibility of an equipment digital twin integrated evolution model, which can achieve rapid online aggregation of errors of an integrated evolution model, fully utilize limited real observation data, and improve accuracy of online evaluation.

In order to achieve the above purpose, the disclosure provides a rapid online evaluation method for credibility of an equipment digital twin integrated evolution model. The equipment digital twin integrated evolution model is an integrated model having multiple levels, and each of the multiple levels includes multiple sub-models. An upper-level sub-model is obtained by solving a relational expression between multiple lower-level sub-models corresponding to the upper-level sub-model and the upper-level sub-model, and an error distribution of the upper-level sub-model is obtained by performing an error aggregation operation on error distributions of the multiple lower-level sub-models corresponding to the upper-level sub-model. The rapid online evaluation method includes:
S1, performing a rapid online aggregation on unit model error distributions to obtain an error aggregation result, including:
   S1.1, dynamically triggering the error aggregation operation, including: dynamically triggering the error aggregation operation according to changes in the unit model error distributions in the equipment digital twin integrated evolution model;
   S1.2, simplifying an aggregation computation tree of the equipment digital twin integrated evolution model according to real-time evolution conditions; and
   S1.3, performing a rapid sampling aggregation on the error distributions according to model mechanisms to obtain the error aggregation result;
S2, performing a rapid posterior correction on the error aggregation result, including: designing a neighborhood correction method, and performing a rapid online correction on the error aggregation result by using Bayesian inference combined with limited real observation data to obtain a corrected error distributions of the equipment digital twin integrated evolution model, thereby improving evaluation accuracy; and
S3, performing online scoring on the corrected error distributions of the equipment digital twin integrated evolution model according to user requirements, including: converting the user requirements into an error scoring mechanism, and calculating a credibility value of the equipment digital twin integrated evolution model according to the corrected error distributions of the equipment digital twin integrated evolution model.

In an exemplary embodiment, the rapid online evaluation method further includes:
comparing the credibility value of the equipment digital twin integrated evolution model obtained in S3 with a preset credibility threshold, including:
in response to the credibility value of the equipment digital twin integrated evolution model greater than or equal to the preset credibility threshold, performing simulation according to the equipment digital twin integrated evolution model to generate a control instruction of equipment, and controlling the equipment according to the control instruction to execute tasks; and
in response to the credibility value of the equipment digital twin integrated evolution model smaller than the preset credibility threshold, generating an alarm signal and prohibiting generating the control instruction based on the equipment digital twin integrated evolution model.

In an embodiment, the dynamically triggering the error aggregation operation in S1.1 specifically includes: for the upper-level sub-model, calculating the error distributions of the multiple lower-level sub-models corresponding to the upper-level sub-model within each evaluation interval, calculating a total variation distance of the error distributions of the multiple lower-level sub-models corresponding to the upper-level sub-model in adjacent evaluation intervals, determining whether the total variation distance exceeds a preset threshold, and triggering the error aggregation operation for the upper-level sub-model in response to the total variation distance exceeds the preset threshold.

In an embodiment, the simplifying an aggregation computation tree of the equipment digital twin integrated evolution model according to real-time evolution conditions in S1.2 specifically includes: in each evaluation interval, for a sub-model that has not undergone evolution update, adopting a calculation result from a last error aggregation operation as an error distribution of the sub-model that has not undergone evolution update; for a sub-model that has undergone evolution update, performing a sampling calculation and updating an error distribution of the sub-model that has undergone evolution update; and performing the error aggregation operation only for the sub-model that has undergone evolution update and an upper-level sub-model corresponding to the sub-model that has undergone evolution update.

In an embodiment, the performing a rapid sampling aggregation on the error distributions according to model mechanisms to obtain the error aggregation result in S1.3 specifically includes: for the upper-level sub-model, performing a random sampling on the error distributions of the multiple lower-level sub-models corresponding to the upper-level sub-model by using a Monte Carlo random sampling method to obtain a sub-model error value combination, and substituting the sub-model error value combination into the relational expression between the multiple lower-level sub-models corresponding to the upper-level sub-model and the upper-level sub-model to obtain an error value of the upper-level sub-model under the sub-model error value combination.

In an embodiment, the performing rapid posterior correction on the error aggregation result in S2 specifically includes:
correcting the error aggregation result by using the limited real observation data, where a core formula (1) of the Bayesian inference is expressed as follows:

$$P ( θ \vert D ) = \frac{P ( D \vert θ ) P ( θ )}{P ( D )} \qquad ( 1 )$$

where θ represents a model parameter distribution, D represents an observed event, P(θ) represents a prior probability of taking the model parameter distribution θ; P(D) represents a sum of probabilities of observing the event D under multiple possible parameter distributions, and is a constant for normalization; P(D|θ) represents a likelihood probability, and is a probability of observing the event D when conforming to the model parameter distribution θ; and P(θ|D) represents a posterior probability, and is a probability of taking the model parameter distribution θ when the event D is observed;
finding an optimal parameter distribution \tilde{θ} maximizing the posterior probability P(θ|D), wherein the optimal parameter distribution \tilde{θ} satisfies the following formula (2):

$$\tilde{θ} = arg max \{ P ( D \vert θ ) P ( θ ) \} \qquad ( 2 )$$

for a current error aggregation result, taking an output of an observed equipment digital twin integrated evolution model as the event D, searching a better parameter distribution within a neighborhood of the current error aggregation result to make P(θ|D) to reach a lager value, and rewriting the formula (1) to a formula (3) as follows to distinguish the multiple possible parameter distributions:

$$P ( {θ}_{i} \vert D ) = \frac{P ( D \vert {θ}_{i} ) P ( {θ}_{i} )}{{\sum }_{i} P ( D \vert {θ}_{i} ) P ( {θ}_{i} )} \qquad ( 3 )$$

where θᵢ is one of the multiple possible parameter distributions, and represents an error distribution parameter obtained by current aggregation that need to be corrected; and
for each parameter value in a parameter distribution corresponding to the current error aggregation result, randomly generating multiple neighborhood values within the neighborhood of the current error aggregation result, and randomly combining the multiple neighborhood values to generate multiple candidate parameter distributions; and calculating a posterior probability P(θ|D) of each of the multiple candidate parameter distributions according to the formula (3), and selecting one of the multiple candidate parameter distributions with a maximum posterior probability as a corrected result, where the corrected result is an error distribution of the equipment digital twin integrated evolution model closest to a real situation at a current moment.

In an embodiment, the performing online scoring on the corrected error distributions of the equipment digital twin integrated evolution model according to user requirements in S3 specifically includes:
establishing a quantitative scoring mechanism for the user requirements regarding different error situations, converting the user requirements into an error scoring function δᵣ, defining a critical value as δₜ, where, when an error value exceeds the critical value as δₜ, a score value drops sharply and rapidly approaches zero; and
performing, according to the error scoring mechanism, online scoring on the error distribution of the equipment digital twin integrated evolution model closest to the real situation at the current moment as the credibility value, wherein the credibility value is expressed as following formula (4):

$$C = {\sum }_{i = 1}^{n} S ( {δ}_{ri} ) * {p}_{i} \qquad ( 4 )$$

where C represents the credibility value; S(δᵣᵢ) represents the error scoring function defined according to the user requirements with an input of the error value δᵣᵢ and an output of the score value; pᵢ is an error probability, and represents a probability of occurrence of the error value δᵣᵢ; and n represents a number of probability bins of the error distribution of the equipment digital twin integrated evolution model closest to the real situation at the current moment, and the probability bins are intervals in which the error distribution of the equipment digital twin integrated evolution model closest to the real situation at the current moment is discretized, and each of the intervals corresponds to an error value δᵣᵢ and an error probability pᵢ.

According to specific embodiments provided by the disclosure, the disclosure has the following technical effects.

Aiming at the rapid online evaluation requirements of the credibility of the equipment digital twin integrated evolution model, the Monte Carlo sampling-based error aggregation method based on model mechanism, the dynamic triggering evaluation method, and the computation tree simplification method are proposed to achieve the rapid online aggregation of the integrated model errors.

Aiming at the problem of errors in the credibility value obtained through aggregation, the rapid posterior correction method based on Bayesian inference is proposed, which makes full use of the limited real observation data, thereby improving the accuracy of the online evaluation.

The technical solutions of the disclosure are further described in detail below through drawings and embodiments.

### BRIEF DESCRIPTION OF DRAWINGS

In order to provide a clearer explanation of technical solutions in embodiments of the disclosure or related art, drawings required in the embodiments will be briefly introduced below.

Apparently, drawings in the following descriptions are merely some of the embodiments of the disclosure, those skilled in the art can obtain other drawings according to these drawings without creative work.

FIG. 1 illustrates a flowchart of a rapid online evaluation method for a credibility of an equipment digital twin integrated evolution model according to an embodiment of the disclosure.

FIG. 2 illustrates a schematic diagram of a mechanism of the equipment digital twin integrated evolution model according to an embodiment of the disclosure.

FIG. 3 illustrates a schematic diagram of a model state of the equipment digital twin integrated evolution model according to an embodiment of the disclosure.

FIG. 4A illustrates an error distribution diagram before error observation according to an embodiment of the disclosure.

FIG. 4B illustrates an error distribution diagram after error observation according to an embodiment of the disclosure.

FIG. 5 illustrates a schematic diagram of a simplified error aggregation computation tree according to an embodiment of the disclosure.

FIG. 6 illustrates a schematic diagram of an equipment mechanism model with multiple types of errors according to an embodiment of the disclosure.

FIG. 7 illustrates a schematic diagram of converting a core requirement into a scoring mechanism according to an embodiment of the disclosure.

### DETAILED DESCRIPTION OF EMBODIMENTS

Technical solutions in embodiments of the disclosure will be clearly and completely described below with reference to drawings in the embodiments of the disclosure. Apparently, the described embodiments are merely some of the embodiments of the disclosure, not all of the embodiments of the disclosure. All other embodiments obtained by those skilled in the art based on the embodiments of the disclosure without creative efforts shall fall within a protection scope of the disclosure.

In order to make the aforementioned objectives, features, and advantages of the disclosure more comprehensible, the following describes the disclosure in further detail with reference to the drawings and specific implementation.

### EMBODIMENT

An equipment digital twin integrated evolution model is an integrated model with multiple levels, and each level includes multiple sub-models. An upper-level sub-model is obtained by solving a relational expression between multiple lower-level sub-models corresponding to the upper-level sub-model and the upper-level sub-model, and an error distribution of the upper-level sub-model is obtained by performing an error aggregation operation on error distributions of the lower-level sub-models corresponding to the upper-level sub-model.

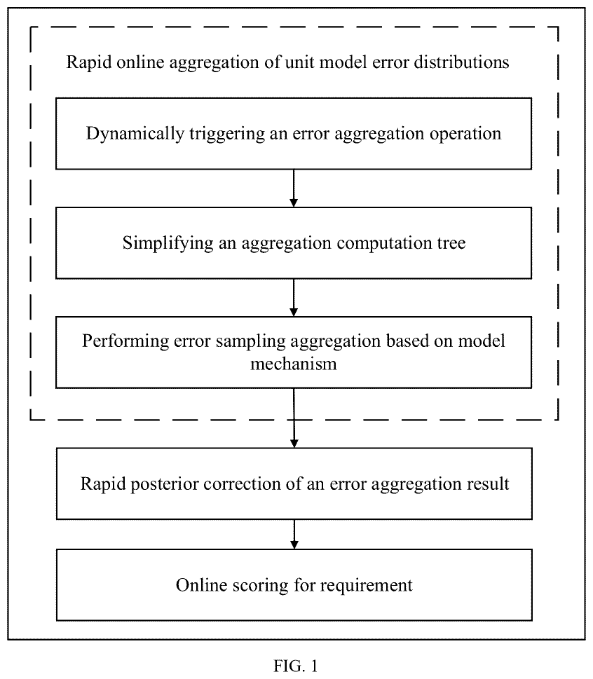

As shown in FIG. 1, a rapid online evaluation method for credibility of an equipment digital twin integrated evolution model includes the following steps S1-S3.

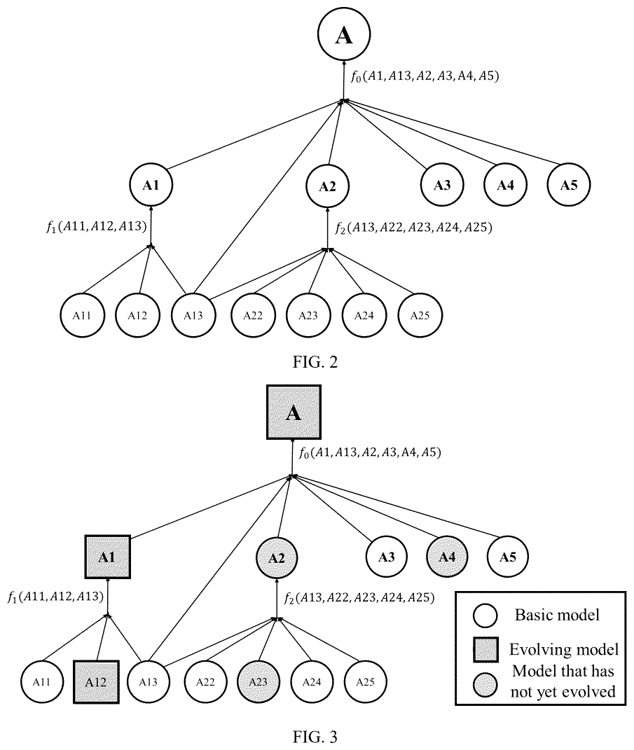

In an equipment mechanism model shown in FIG. 2, A represents a system-level output, A1-A5 and A13 represent lower-level sub-models corresponding to A, A11-A13 represent lower-level sub-models corresponding to A1, and A22-A25 and A13 represent lower-level sub-models corresponding to A2. f₀ represents an expression composed of outputs A1, A13, A2, A3, A4, and A5 of the sub-models, from which an output value of A can be obtained. These expressions are generally ordinary differential equation systems. f₁, f₂, and the like follow the same principle.

In step S1, rapid online aggregation of unit model error distributions (i.e., sub-model error distributions corresponding to the upper-level sub-model to be updated) is performed. The step S1 specifically includes the following steps S1.1-S1.3.

In step S1.1, an error aggregation operation is dynamically triggered. Specifically, the error aggregation operation is dynamically triggered according to changes in the unit model error distributions in the equipment digital twin integrated evolution model.

As shown in FIG. 3, in each evaluation interval, the actual equipment digital twin integrated evolution model has three types of model states, including basic models that never participate in evolution, models currently evolving during the evaluation, and models not yet evolved during the evaluation. Apart from the currently evolving models, the evaluation conclusions for the other two types can inherit results from a previous evaluation moment, as their errors are small enough not to require participation in evolution. In the case of FIG. 2, all sub-models are basic models, once the sub-model error distributions are confirmed, only one aggregation calculation as described in S3 is needed to determine the error distribution of the integrated model. However, in the case of FIG. 3, there exists an evolving sub-model A12, its error distribution is continuously updated based on real-time observation data. Consequently, the aggregated error distributions of the integrated models A1 and A also change continuously. Theoretically, each time sub-model A12 completes an evolution update, the true value of its error distribution changes. It then requires a period of observation to confirm its changed error distribution before updating the error distribution of the integrated model.

It is important to note that the error aggregation algorithm requires a certain amount of time to execute, while model evolution is continuous. If sampling aggregation is performed after every evolution, it will consume significant resources. In reality, although sub-model evolution is continuous, the magnitude of change in sub-model error is uncertain. Most of the time, the sub-model error does not change or changes only slightly, in which case the previous aggregation result does not need to be altered. Only when the sub-model error changes significantly is it necessary to update the error of the integrated model.

In order to improve aggregation speed, the disclosure designs an appropriate timing for dynamic aggregation, which can both ensure aggregation accuracy and significantly increase calculation speed, better meeting the evaluation requirements for digital twins. For the upper-level sub-model, within each evaluation interval, the error distributions of its corresponding lower-level sub-models are calculated. Then, a total variation distance between the error distributions of these sub-models in adjacent evaluation intervals is calculated. It is determined whether the total variation distance exceeds a preset threshold. When the total variation distance of the error distributions exceeds the preset threshold, the error aggregation operation for the upper-level sub-model is triggered.

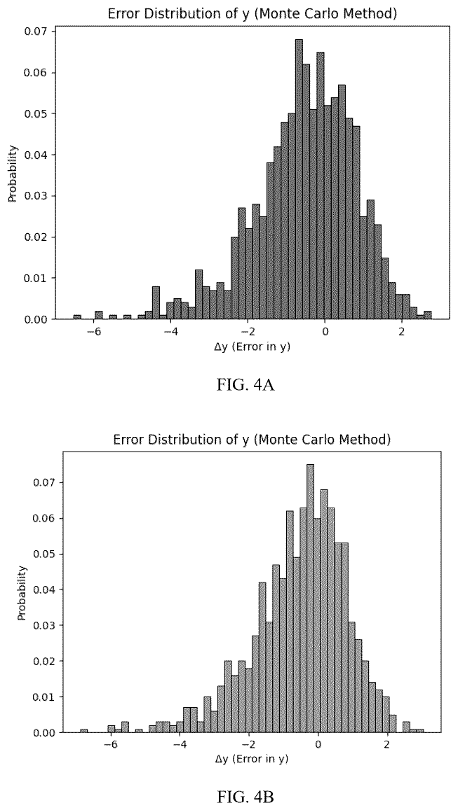

As shown in FIGS. 4A-4B, after a period of error observation, the output error distribution of a certain sub-model changed from FIG. 4A to FIG. 4B. Examining the output error of this sub-model, in specific scenarios, although events encountered by the equipment are uncertain, their frequency distribution is relatively determinate. Under each event, the model error change caused by the same evolution algorithm is also relatively determinate. Therefore, if the observation data is sufficiently comprehensive, the statistically derived overall error distribution should be relatively stable. It can be considered that if the error distribution shows almost no change as statistical data increases, it indicates that this distribution is very close to the true distribution. In an intermediate stage when data is not yet sufficiently comprehensive, the statistically derived error distribution may not cover all possibilities and thus may still exhibit some change.

For intuitive display and computational convenience, the error distribution is subjected to uniform discretization. That is, for the same sub-model, the same error range is specified, and the error intervals are divided with the same spacing. Therefore, on the error distribution diagrams of two consecutive versions of the same sub-model, each frequency bin represents the same error meaning. Thus, a sum of differences of corresponding frequency bins between two adjacent error distribution diagrams can represent the difference between the adjacent error distributions. Furthermore, a distribution probability in each error distribution diagram is normalized, thus, this sum of differences can significantly reflect a disparity between the error distribution diagrams. Each error distribution diagram is evenly divided into 50 frequency bins. Assuming that FIG. 4A is an error distribution diagram statistically obtained at time t1, its frequency values for each frequency bin is

$${b}_{t 1}^{1} , {b}_{t 1}^{1} , ... , {b}_{t 1}^{50} .$$

Assuming that FIG. 4B is an error distribution diagram statistically obtained at time t2, its frequency values for each frequency bin is

$${b}_{t 2}^{1} , {b}_{t 2}^{2} , … , {b}_{t 2}^{50} ,$$

thus, a calculation formula of a total variation distance dₜ₁ₜ₂ between the FIG. 4A and FIG. 4B is expressed as follows:

$${d}_{t 1 t 2} = {\sum }_{i = 1}^{50} \vert {b}_{t2}^{i} - {b}_{t2}^{i} \vert \qquad ( 5 )$$

Therefore, the timing for necessary aggregation can be confirmed by combining the magnitude of evolution change. That is, the latest error distribution is compared with the error distribution from the last update, and the total variation distance dₜ₁ₜ₂ between the two error distributions is calculated. If the total variation distance exceeds the preset threshold, the error aggregation operation is triggered. After using this method, it can ensure the precision of aggregation results while concentrating limited computational resources on more essential operations, thereby improving calculation speed, and better meeting the high-speed requirements of digital twin evaluation.

In step S1.2, an aggregation computation tree of the equipment digital twin integrated evolution model is simplified according to real-time evolution conditions.

Although the timing of error aggregation can be dynamically judged and optimized through S1.1, there may still be instances of two evolutions occurring in a short interval with significant changes, leaving limited time for aggregation between them. Therefore, it is necessary to further simplify unnecessary calculations during aggregation to improve the speed of error aggregation.

As shown in FIG. 3, during this evaluation interval, only A12, A1, and A underwent evolution updates. Consequently, only the output error distributions of these three models changed. All other models did not evolve due to their small errors, thus their error distributions can inherit the conclusions from the last aggregation. That is, a core of simplifying the computation tree lies in: within the evaluation interval, for sub-models that have not undergone evolution update, their error distribution adopts the calculation result from the last aggregation; for sub-models that have undergone evolution update, new sampling calculations are performed and their error distributions are updated; and the error aggregation calculation is performed only for the models that have evolved and their related upper-level models.

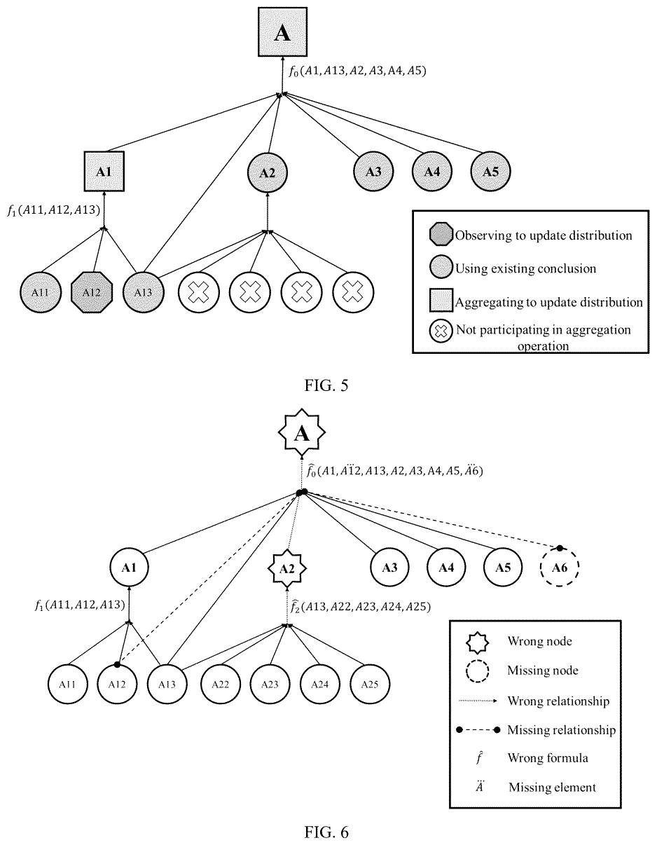

According to the evolution relationships of each model in FIG. 5, the simplified error aggregation calculation tree is shown in FIG. 5. A11, A13, A2, A3, A4, and A5 do not require evolution during the evaluation period, thus their error distribution conclusions from the last evaluation can be used directly. Since A2 can directly use the previous conclusion, its related sub-models no longer need to participate in the aggregation operation. A12, A1, and A are the parts that evolved during the evaluation period and require updating their error distributions. Among them, A12 is an end node, and its distribution can only be updated by observing new data. A1 and A are intermediate nodes, and their distributions need to be updated through error aggregation. Ultimately, only A1 and A require error aggregation operations.

In step S1.3, a rapid sampling aggregation is performed on the error distributions of the lower-level sub-models corresponding to the upper-level sub-model according to model mechanism.

A complexity of a traditional theoretical aggregation method, which involves dividing intervals and traversing combinations, is O(n^{k}), where k represents the number of the sub-models, and n represents the number of samples. This computational complexity is exceedingly high for equipment models composed of dozens or even hundreds of sub-models, resulting in excessive time consumption and making it unsuitable for online aggregation evaluation. Therefore, the sampling method for error points is changed to Monte Carlo random sampling.

The advantage of the Monte Carlo method lies in the independence of calculation for each random sample, making it easily parallelizable and suitable for large-scale computation, thereby significantly improving aggregation speed. However, in order to obtain sufficiently accurate results, a large number of random samples is typically required, which leads to considerable computational overhead, especially when facing high precision requirements. The accuracy of the Monte Carlo method relies on the number of samples. According to a law of large numbers, as the sample size increases, the estimated value approaches the true value. Assuming that n independent random experiments are conducted, the error typically decreases as the sample size increases. Specifically, a standard deviation of the error is usually

$$\frac{1}{\sqrt{n}} ,$$

thus, increasing the sampling number n can reduce estimation error.

Combining a scenario of online evaluation for equipment digital twins, when applying this method for aggregation, sampling is generally performed on relatively small-scale unit models with simpler error distributions (without multi-modal situations), thus sampling points do not need to be overly dense. However, aggregation speed requirements are high since it is necessary to quickly learn the current error situation of the integrated model to understand its degree of satisfaction for the current application requirements. From this perspective, the Monte Carlo method is suitable for this scenario.

For an upper-level sub-model, the Monte Carlo random sampling method is employed to perform a random sampling on the error distributions of lower-level sub-models corresponding to the upper-level sub-model, thereby obtaining a possible sub-model error value combination. According to the associated mechanisms shown in FIG. 3, the error values (i.e., the possible sub-model error value combination) are substituted into a relational expression between the upper-level sub-model and the lower-level sub-models corresponding to the upper-level sub-model, to obtain an error value of the upper-level sub-model under that specific error value combination. The error value of sub-model A1 in FIG. 3 is taken as an example, one sampling is performed separately according to the error frequency distributions of A11, A12, and A13 to obtain δ₁₁, δ₁₂, and δ₁₃. δ₁₁, δ₁₂, and δ₁₃ are substituted into f₁(A11, A12, A13) to obtain an error δ₁ of A1 under this error combination as follows:

$${δ}_{1} \approx {f}_{1} ( {δ}_{11} , {δ}_{12} , {δ}_{13} ) \qquad ( 6 )$$

Output error distributions of A1 and A2 are combined with the already obtained error distributions of A3, A4, and A5, an approximate value of an output error distribution of the integrated model A can be further calculated. Based on this error distribution and the actual application requirements, a degree to which this integrated model A satisfies the application requirements can be analyzed.

In step S2, rapid posterior correction is performed on the error aggregation result. Specifically, a Bayesian inference is utilized, and limited real observation data is combined to correct the error aggregation result, thereby improving evaluation accuracy.

The equipment mechanism models in the related art have multiple types of errors that are difficult to eliminate compared to actual physical equipment. As shown in FIG. 6, all parts containing deviations are marked, and dashed lines indicate missing parts. Specifically, A6 is a missing element. For example, environmental humidity parameters significantly affect model performance, but due to insufficient developer cognition or limited computational capability, they are not incorporated into the mechanism model. Consequently, the influence mechanism of A6 on A is not written into the f₀ relational expression. Furthermore, although A12 is included in the mechanism model, its direct influence on the integrated model A is not written into the f₀ relational expression; it only indirectly influences A through A1. In the A2 part, although the main elements influencing A2 are complete, the representation f₂ of their influence mechanism on A2 has a certain deviation. Therefore, during simulation, the value of A2 continuously accumulates error, and these errors are further transmitted into the error of the integrated model A. The aforementioned errors are unavoidable during the model development stage and cause the error aggregation results from S1 to deviate from the actual errors.

In order to obtain more accurate evaluation results for the integrated evolution model, it is necessary to more fully utilize the obtainable observation data. Although observation data for the integrated model is scarce and cannot be directly analyzed to obtain its error distribution, this limited data can be used to correct the existing error aggregation result.

First, the limited real observation data is utilized to correct the error aggregation result, and a core formula (1) of the adopted Bayesian inference is as follows:

$$P ( θ \vert D ) = \frac{P ( D \vert θ ) P ( θ )}{P ( D )} \qquad ( 1 )$$

where θ represents a model parameter distribution, D represents an observed event, P(θ) represents a prior probability of taking the model parameter distribution θ; P(D) represents a sum of probabilities of observing the event D under a plurality of possible parameter distributions, and is a constant for normalization; P(D|θ) represents a likelihood probability, and is a probability of observing the event D when conforming to the model parameter distribution θ; and P(θ|D) represents a posterior probability, and is a probability of taking the model parameter distribution θ when the event D is observed.

The goal is to find an optimal parameter distribution \tilde{θ} that maximizes the posterior probability P(θ|D), and the optimal parameter distribution \tilde{θ} satisfies the following formula (2):

$$\tilde{θ} = arg max \{ P ( D \vert θ ) P ( θ ) \} \qquad ( 2 )$$

However, this formula involves many parameters, and the expression may be complex, making it difficult to provide an accurate expression relationship or to find the optimal \tilde{θ} within a short time. It is noted that for equipment digital twins, the output observation data of the integrated model is limited. Therefore, the statistical distribution of output errors of the integrated model has a certain deviation from the true distribution. Consequently, the correction based on this data should not be too drastic; it should be similar to the backpropagation in neural networks, gradually and moderately adjusting. As observation data for the integrated model increases, the correction accuracy will become higher, and the aggregation results can be more effectively corrected.

Therefore, a core of correction is, aiming at the current error aggregation result, taking the observed integrated evolution model output as the event D, and searching within a neighborhood of the current error aggregation result for a better parameter distribution that yields a larger value for P(θ|D).

In order to distinguish various possible parameter distributions, the formula (1) is rewritten as follows:

$$P ( {θ}_{i} \vert D ) = \frac{P ( D \vert {θ}_{i} ) P ( {θ}_{i} )}{{Σ}_{i} P ( D \vert {θ}_{i} ) P ( {θ}_{i} )} \qquad ( 3 )$$

where θᵢ is one of all possible parameter distributions, which represents an error distribution parameter obtained by the current aggregation that need to be corrected, i.e., the 50 frequency bin values

$${b}_{t 2}^{1} , {b}_{t 2}^{2} , … , {b}_{t 2}^{50}$$

of the latest error distribution in formula (5).

Finally, for each parameter value in a parameter distribution corresponding to the current error aggregation result, multiple new neighborhood values are randomly generated within the neighborhood of the current error aggregation result. Multiple candidate parameter distributions are generated by randomly combining the neighborhood values of all parameters. For each candidate parameter distribution, the posterior probability P(θᵢ|D) is calculated according to the formula (3). The parameter distribution with the highest posterior probability is selected as the correction result, which represents the error distribution of the integrated evolution model closest to the real situation at the current moment.

For example, for

$${b}_{t 2}^{1} ,$$

10 new neighborhood values can be randomly selected within the neighborhood of each frequency bin value according to the following formula (7):

$${{b}^{′}}_{t 2}^{1} = {b}_{t 2}^{1} + 5 \% * {b}_{t 2}^{1} * rand ( - 1 , 1 ) \qquad ( 7 )$$

where rand(−1, 1) represents randomly selecting a value within a range [−1, 1].

10 new sets of frequency value compositions are randomly selected from the 50 groups of prepared neighborhood values as candidate parameter distributions within the neighborhood. For each parameter distribution, a probability of obtaining that parameter distribution given the currently observed integrated model output error can be calculated according to formula (6). Finally, from the 10 sets of frequency value combinations, the one with the highest posterior probability is selected as the corrected parameter distribution. If more time is available for correction, the number of frequency value combinations drawn from the neighborhood can be increased to search for an optimal parameter distribution.

In step S3, online scoring is performed on the corrected error distributions of the integrated evolution model according to the user requirements. Specifically, a better way to describe model error is through the error distribution, which corresponds the probability of occurrence to the different gaps between the model output and actual data. In order to evaluate model credibility based on the error distribution, it is necessary to convert user requirements into a scoring mechanism for different error situations.

First, a quantitative scoring mechanism is established for user requirements regarding different error situations. The user requirements are converted into an error scoring function δᵣ, a critical value is defined as δₜ. If the error value exceeds the critical value δₜ, the score value will drop sharply and rapidly approach 0.

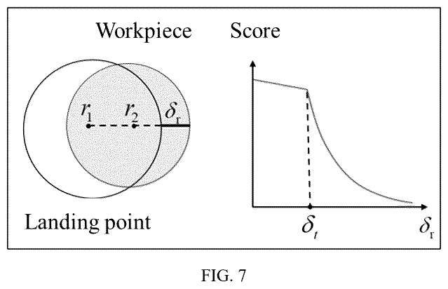

A robotic arm sorting application is taken as an example, the digital twin model of the robotic arm is overall an integrated model with continuously evolving unit models such as motor unit models, kinematic models, and geometric models. Before each sorting application, based on simulation results of the latest version of the twin model, optimal control signals are determined to ensure sorting accuracy. Its core requirement is to accurately transfer the workpiece to a center of a downstream conveyor belt. The farther the deviation, the greater the impact on the subsequent processing. Exceeding a certain deviation threshold will cause conveyor line blockage. This core requirement is converted into a scoring mechanism as shown in FIG. 7.

Specifically, the landing point is an area with r₁ as a center, the workpiece is an object with r₂ as a center, and δᵣ is a maximum deviation by which the workpiece exceeds the landing point area. According to user requirements, the larger δᵣ is, the lower the score for each sorting application will be. There is a critical value St. If this value is exceeded, it means the workpiece deviation is too large and will seriously affect subsequent processing, thus the score will drop sharply, rapidly approaching 0. The critical value and the formulas for the two segments of the curve are determined based on specific user requirements to obtain a quantitative scoring mechanism for different error situations.

Then, online scoring is performed on the error distribution of the integrated evolution model closest to the real situation at the current moment obtained in S2 according to the error scoring mechanism as the credibility value, which is expressed as follows:

$$C = {Σ}_{i = 1}^{n} S ( {δ}_{r i} ) * {p}_{i} \qquad ( 4 )$$

where C represents the credibility value; S(δᵣᵢ) represents the error scoring function defined according to the user requirements with an input of the error value δᵣᵢ and an output of the score value; pᵢ is an error probability, and represents a probability of occurrence of the error value δᵣᵢ; n represents the number of probability bins of the error distribution. The probability bins are intervals in which the error distribution is discretized, each interval corresponding to an error value δᵣᵢ and an error probability pᵢ.

According to the scoring mechanism in FIG. 7, the error value δᵣᵢ corresponding to each bin is converted into a score value S(δᵣᵢ), which is then multiplied by the probability value pᵢ of that bin to obtain a contribution value of each bin to the overall credibility. The contribution values are accumulated bin by bin to obtain the overall credibility value of the integrated evolution model. As observation data increases, the obtained error distribution will become increasingly closer to the true value, thus the credibility value obtained by scoring will fluctuate and approach the true value. When the fluctuation amplitude remains stable within a small range over the long term, the obtained credibility value can be regarded as the true credibility value of the equipment digital twin integrated evolution model under that demand scenario.

The remaining technical features in the above embodiments can be flexibly selected by those skilled in the art according to actual situations to meet different specific practical needs. However, it is obvious to those skilled in the art that these specific details are not necessary to implement the disclosure. In other instances, well-known components, structures, or parts have not been specifically described to avoid obscuring the disclosure, all of which fall within the technical protection scope defined by the claims of the disclosure.

Modifications and variations made by those skilled in the art without departing from the spirit and scope of the disclosure shall fall within the protection scope of the appended claims of the disclosure. In the above description, numerous specific details are set forth to provide a thorough understanding of the disclosure. However, it will be apparent to those skilled in the art that these specific details are not required to practice the disclosure. In other instances, well-known techniques, such as specific construction details, operating conditions, and other technical conditions, have not been described in detail to avoid obscuring the disclosure.

Specific examples are used in this document to illustrate the principles and implementations of the disclosure. The descriptions of the above embodiments are only intended to help understand the method and core ideas of the disclosure. Meanwhile, for those skilled in the art, modifications may be made to the specific implementations and application scope based on the ideas of the disclosure. In summary, the content of this specification shall not be construed as limiting the disclosure.

What is claimed is:

1. A rapid online evaluation method for credibility of an equipment digital twin integrated evolution model, wherein the equipment digital twin integrated evolution model is an integrated model having a plurality of levels, each of the plurality of levels comprises a plurality of sub-models, an upper-level sub-model is obtained by solving a relational expression between a plurality of lower-level sub-models corresponding to the upper-level sub-model and the upper-level sub-model, and an error distribution of the upper-level sub-model is obtained by performing an error aggregation operation on error distributions of the plurality of lower-level sub-models corresponding to the upper-level sub-model, and the method comprises:
S1, performing a rapid online aggregation on unit model error distributions to obtain an error aggregation result, comprising:
S1.1, dynamically triggering the error aggregation operation, comprising: dynamically triggering the error aggregation operation according to changes in the unit model error distributions in the equipment digital twin integrated evolution model;
S1.2, simplifying an aggregation computation tree of the equipment digital twin integrated evolution model according to real-time evolution conditions; and
S1.3, performing a rapid sampling aggregation on the error distributions according to model mechanisms to obtain the error aggregation result;
S2, performing a rapid posterior correction on the error aggregation result, comprising: designing a neighborhood correction method, and performing a rapid online correction on the error aggregation result by using Bayesian inference combined with limited real observation data to obtain a corrected error distributions of the equipment digital twin integrated evolution model, thereby improving evaluation accuracy; and
S3, performing online scoring on the corrected error distributions of the equipment digital twin integrated evolution model according to user requirements, comprising: converting the user requirements into an error scoring mechanism, and calculating a credibility value of the equipment digital twin integrated evolution model according to the corrected error distributions of the equipment digital twin integrated evolution model.

2. The rapid online evaluation method for credibility of the equipment digital twin integrated evolution model as claimed in claim 1, wherein the dynamically triggering the error aggregation operation in S1.1 comprises: for the upper-level sub-model, calculating the error distributions of the plurality of lower-level sub-models corresponding to the upper-level sub-model within each evaluation interval, calculating a total variation distance of the error distributions of the plurality of lower-level sub-models corresponding to the upper-level sub-model in adjacent evaluation intervals, determining whether the total variation distance exceeds a preset threshold, and triggering the error aggregation operation for the upper-level sub-model in response to the total variation distance exceeds the preset threshold.

3. The rapid online evaluation method for credibility of the equipment digital twin integrated evolution model as claimed in claim 2, wherein the simplifying an aggregation computation tree of the equipment digital twin integrated evolution model according to real-time evolution conditions in S1.2 comprises: in each evaluation interval, for a sub-model that has not undergone evolution update, adopting a calculation result from a last error aggregation operation as an error distribution of the sub-model that has not undergone evolution update; for a sub-model that has undergone evolution update, performing a sampling calculation and updating an error distribution of the sub-model that has undergone evolution update; and performing the error aggregation operation only for the sub-model that has undergone evolution update and an upper-level sub-model corresponding to the sub-model that has undergone evolution update.

4. The rapid online evaluation method for credibility of the equipment digital twin integrated evolution model as claimed in claim 3, wherein the performing a rapid sampling aggregation on the error distributions according to model mechanisms to obtain the error aggregation result in S1.3 comprises: for the upper-level sub-model, performing a random sampling on the error distributions of the plurality of lower-level sub-models corresponding to the upper-level sub-model by using a Monte Carlo random sampling method to obtain a sub-model error value combination, and substituting the sub-model error value combination into the relational expression between the plurality of lower-level sub-models corresponding to the upper-level sub-model and the upper-level sub-model to obtain an error value of the upper-level sub-model under the sub-model error value combination.

5. The rapid online evaluation method for credibility of the equipment digital twin integrated evolution model as claimed in claim 1, wherein the performing rapid posterior correction on the error aggregation result in S2 comprises:
correcting the error aggregation result by using the limited real observation data, wherein a core formula (1) of the Bayesian inference is expressed as follows:
$$P ( θ \vert D ) = \frac{P ( D \vert θ ) P ( θ )}{P ( D )} \qquad ( 1 )$$
wherein θ represents a model parameter distribution, D represents an observed event, P(θ) represents a prior probability of taking the model parameter distribution θ; P(D) represents a sum of probabilities of observing the event D under a plurality of possible parameter distributions, and is a constant for normalization; P(D|θ) represents a likelihood probability, and is a probability of observing the event D when conforming to the model parameter distribution θ; and P(θ|D) represents a posterior probability, and is a probability of taking the model parameter distribution θ when the event D is observed;
finding an optimal parameter distribution \tilde{θ} maximizing the posterior probability P(θ|D), wherein the optimal parameter distribution \tilde{θ} satisfies the following formula (2):
$$\tilde{θ} = arg max \{ P ( D \vert θ ) P ( θ ) \} \qquad ( 2 )$$
for a current error aggregation result, taking an output of an observed equipment digital twin integrated evolution model as the event D, searching a better parameter distribution within a neighborhood of the current error aggregation result to make P(θ|D) to reach a lager value, and rewriting the formula (1) to a formula (3) as follows to distinguish the plurality of possible parameter distributions:
$$P ( {θ}_{i} \vert D ) = \frac{P ( D \vert {θ}_{i} ) P ( {θ}_{i} )}{{Σ}_{i} P ( D \vert {θ}_{i} ) P ( {θ}_{i} )} \qquad ( 3 )$$
wherein θᵢ is one of the plurality of possible parameter distributions, and represents an error distribution parameter obtained by current aggregation that need to be corrected; and
for each parameter value in a parameter distribution corresponding to the current error aggregation result, randomly generating a plurality of neighborhood values within the neighborhood of the current error aggregation result, and randomly combining the plurality of neighborhood values to generate a plurality of candidate parameter distributions; and calculating a posterior probability P(θ|D) of each of the plurality of candidate parameter distributions according to the formula (3), and selecting one of the plurality of candidate parameter distributions with a maximum posterior probability as a corrected result, wherein the corrected result is an error distribution of the equipment digital twin integrated evolution model closest to a real situation at a current moment.

6. The rapid online evaluation method for credibility of the equipment digital twin integrated evolution model as claimed in claim 5, wherein the performing online scoring on the corrected error distributions of the equipment digital twin integrated evolution model according to user requirements in S3 comprises:
establishing a quantitative scoring mechanism for the user requirements regarding different error situations, converting the user requirements into an error scoring function δᵣ, defining a critical value as δₜ, wherein, when an error value exceeds the critical value as δₜ, a score value drops sharply and rapidly approaches zero; and
performing, according to the error scoring mechanism, online scoring on the error distribution of the equipment digital twin integrated evolution model closest to the real situation at the current moment as the credibility value, wherein the credibility value is expressed as following formula (4):
$$C = {Σ}_{i = 1}^{n} S ( {δ}_{r i} ) * {p}_{i} \qquad ( 4 )$$
wherein C represents the credibility value; S(δᵣᵢ) represents the error scoring function defined according to the user requirements with an input of the error value δᵣᵢ and an output of the score value; pᵢ is an error probability, and represents a probability of occurrence of the error value δᵣᵢ; and n represents a number of probability bins of the error distribution of the equipment digital twin integrated evolution model closest to the real situation at the current moment, and the probability bins are intervals in which the error distribution of the equipment digital twin integrated evolution model closest to the real situation at the current moment is discretized, and each of the intervals corresponds to an error value δᵣᵢ and an error probability pᵢ.
